(19) United States
(12) Patent Application Publication
(10) Pub. No.: US 2007/0208500 A1
(43) Pub. Date: Sep. 6, 2007

(54) System for detecting vehicle traffic by means of an on-board co-operational telematic platform based upon extended floating car data

(76) Inventors: Fulvio Sommariva, Orbassano (IT); Francesco Lilli, Orbassano (IT); Filippo Visintainer, Orbassano (IT); Enrico Betterle, Padova (IT); Marco Darin, Orbassano (IT)

Correspondence Address: MITCHELL P. BROOK;C/O LUCE, FORWARD, HAMILTON & SCRIPPS LLP, 11988 EL CAMINO REAL, SUITE 200, SAN DIEGO, CA, 92130, US

(21) Appl. No.: 11/701,953

(22) Filed: Feb. 1, 2007

(30) Foreign Application Priority Data
Feb. 2, 2006 (EP) 06425052.5

(51) Int. Cl. G08G 1/00

(52) U.S. Cl. 701/117

(57) ABSTRACT

Described herein is a telematic apparatus, which can be installed on board a road vehicle for detecting a set of vehicle information regarding the road traffic present around the road vehicle itself, and is designed to transmit said vehicle information to a remote operating center that processes it in order to supply a set of indications regarding the condition of the road traffic; the telematic apparatus comprising: a traffic-congestion detector module for estimating, as a function of a set of vehicle parameters correlated to a set of operating quantities of the road vehicle, a total-traffic index correlated to the likelihood of presence of a condition of traffic congestion around the road vehicle; and a control module, which verifies whether the total-traffic index satisfies a first relation with a pre-set threshold, and issues a command for transmission of the vehicle information to the remote operating center when said relation is satisfied.

### CROSS REFERENCE TO RELATED APPLICATION

Priority is claimed to European Patent Application No. 06425052.5, filed Feb. 2, 2006, the contents of which are incorporated herein by reference.

### FIELD OF THE INVENTION

The present invention relates to a system for detecting vehicle traffic by means of an on-board co-operational telematic platform based upon extended Floating Car Data.

### BACKGROUND OF THE INVENTION

In particular, the present invention regards a system that is able to recognize in an altogether automatic way a state of congestion of road traffic due to circulation of road vehicles, in particular motor vehicles, to which the ensuing treatment will make explicit reference without this implying any loss of generality.

As is known, some of the currently used traffic-detection systems comprise a remote operating center and a set of telematic vehicles, installed on board which are telematic platforms based upon Floating Car Data, referred to hereinafter by the acronym “FCD”.

Each telematic platform based upon FCD is typically constituted by an FCD telematic apparatus, which has the function of supplying, by recording and through a wireless communication, the information on the speed of the road vehicle to the remote operating center, which, in turn, processes the information itself to determine, on the basis of the speeds transmitted also by the other road vehicles provided with the same FCD telematic apparatus, a set of information on the congestion of the road traffic and/or on the optimal path that the road vehicle must follow.

Even though detection systems that use the FCD telematic apparatuses described above are particularly effective in supplying information on traffic to motor-vehicle users, they are able to guarantee a sufficient degree of reliability only if they are installed on a particularly high number of circulating road vehicles. Experimental tests have, in fact, demonstrated that, in order to guarantee a sufficient threshold of reliability of traffic information, it is necessary to install the FCD telematic apparatus on a number of vehicles equal to at least 5% of the total number of circulating vehicles.

It is moreover known that in the last few years the technical evolution of telematic platforms based upon FCD has lead to the creation of the so-called platforms based upon extended Floating Car Data, hereinafter referred to as “xFCD” telematic apparatuses, which are able to transmit to the remote operating center, in addition to the speed of the vehicle, also a plurality of other vehicle data, which are made available by the various control systems and/or by the sensors typically installed on board latest-generation road vehicles.

In particular, xFCD telematic apparatuses detect a set of vehicle parameters, such as the average speed and the variations of speed of the respective vehicle, in such a way as to identify, as a function of the latter and on the basis of the vehicle data received at input, conditions correlated to the environment external to the vehicle, such as poor weather conditions, dangerous road conditions, etc., so as to be able to transmit said information to the remote operating center.

In the case in point, the vehicle data processed by the xFCD telematic system typically comprise: information regarding the state of operation of the windscreen wipers, rain-detecting sensors, vehicle lighting devices (lights associated to the brake control, driving-beam headlights, fog lights), external thermometer, heating devices, air-conditioning devices, sensors for the control system for controlling vehicle dynamics, aid-to-driving devices (ABS, ESP, collision sensors, etc.), additional sensors (telecameras, radars, ladars, microphones, etc.), and so on.

Following upon detection of the aforesaid vehicle data, the xFCD telematic apparatus transmits said data to the remote operating center via a mobile-phone network (GSM/GPRS/SMS). Once the operating center has received the information gathered, it processes it to determine the condition of traffic of road vehicles in such a way as to be able to transmit information or warnings on the traffic to the users of road vehicles.

The xFCD telematic apparatuses described above present the major drawback of having to perform a constant transmission to the operating center of a large amount of data, a fact that leads to excessive communication costs for the service provider. In fact, the cost of the communications made through some of the communication systems currently in use, such as, for example, GPRS systems, is calculated on the basis of the amount of information that is transmitted, which consequently discourages adoption of this mode of data transmission. In addition, the treatment and storage of a large amount of data requires a more complex management of the data by the operating center.

### SUMMARY OF THE INVENTION

The aim of the present invention is hence to provide a system for automatic detection of vehicle traffic by means of xFCD telematic apparatuses installed on board road vehicles, which will reduce the amount of data transmitted to the operating center in such a way as to minimize the transmission costs and simplify data processing and management in the remote operating center in order to contain vehicle information.

According to the present invention, an on-board co-operational telematic apparatus based upon xFCD is hence provided according to what is indicated in claim 1 and, preferably, in any one of the subsequent claims depending either directly or indirectly upon claim 1.

According to the present invention, a system for automatic detection of vehicle traffic by means of an on-board co-operational telematic apparatus based upon xFCD is moreover provided according to what is indicated in claim 12.

### BRIEF DESCRIPTION OF THE FIGURES

The present invention will now be described with reference to the annexed plate of drawings, which illustrate a non-limiting example of embodiment thereof, and in which:

FIG. 1 is a schematic illustration of a system for automatic detection of vehicle traffic by means of an on-board co-operational telematic apparatus based upon xFCD provided according to the teachings of the present invention;

FIG. 2 shows a block diagram of the processing device comprised in the telematic apparatus installed on board each road vehicle shown in FIG. 1;

FIG. 3 illustrates a block diagram of a traffic-congestion detector module comprised in the processing device shown in FIG. 2;

FIGS. 4-11 illustrate as many examples of functions implemented by the traffic-congestion detector module shown in FIG. 3 in order to determine the contribution quantities Cᵢ; and

FIG. 12 is a schematic illustration of the components of a decision-making block comprised in the traffic-congestion detector module shown in FIG. 3.

### DETAILED DESCRIPTION OF THE INVENTION

The present invention is essentially based upon the principle of using at least one road vehicle provided with an on-board co-operational telematic apparatus based upon xFCD for estimating the condition of the traffic present around the road vehicle according to a set of vehicle information detected, and of transmitting said estimate and/or the detected vehicle information to the remote operating center, when the estimated traffic condition corresponds to a condition of traffic congestion.

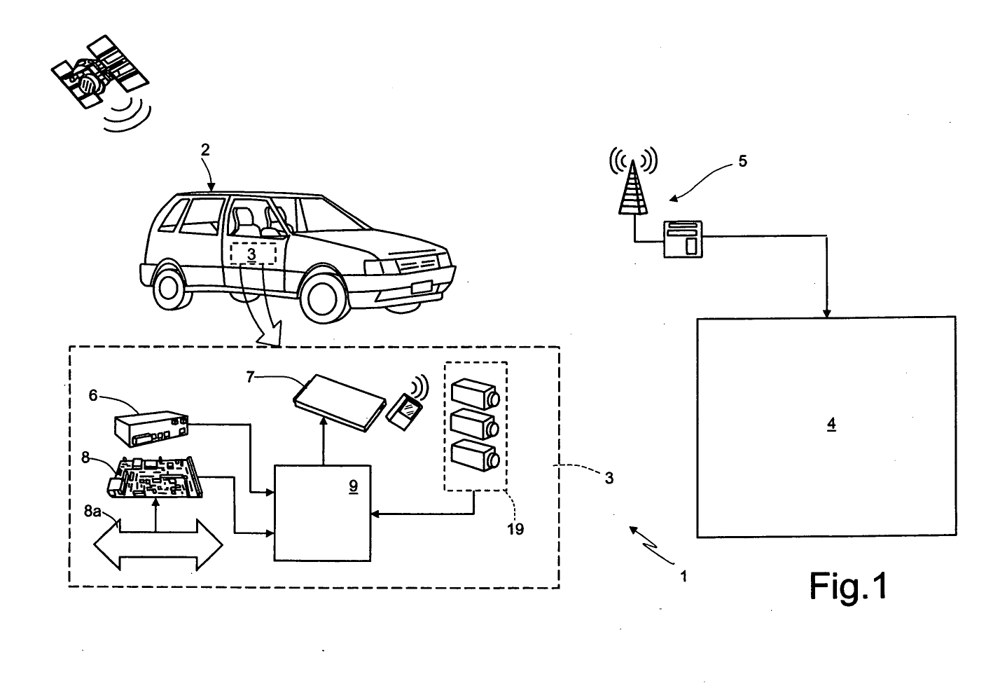

With reference to FIG. 1, number 1 designates as a whole a system for detection of vehicle traffic, which basically comprises a plurality of vehicles 2, installed on board each of which is a telematic platform based upon xFCD, hereinafter referred to as “telematic apparatus 3”, which is designed to process a set of vehicle data (described in detail in what follows) for estimating, on the basis thereof, the condition of vehicle traffic present around the vehicle 2. It should be pointed out that the vehicles 2 correspond to road vehicles, in particular motor vehicles, only one of which is shown for simplicity of description in FIG. 1.

The system 1 further comprises a remote operating center 4, which is able to communicate with the telematic apparatuses 3 installed on board the road vehicles 2 through a communication system 5 so as to receive from each on-board telematic apparatus 3 the vehicle information and the estimates on the conditions of the traffic detected around the road vehicles 2. In particular, the communication system 5 can comprise a telephone network, such as, for example, a mobile-phone network implementing the communication standard GSM, GPRS, SMS, or the like.

With reference to FIG. 1, the telematic apparatus 3 installed on board the road vehicle 2 basically comprises a GPS (Global Positioning System) receiver device 6, able to supply a set of information regarding the position of the road vehicle 2 with respect to a pre-set common reference system. In particular, the receiver device 6 supplies a set of vehicle data, hereinafter referred to as “GPS vehicle data”, which comprise the latitude, longitude, direction of movement of the vehicle, and state of the GPS signal indicating the correctness of the GPS data received.

The telematic apparatus 3 further comprises a transceiver module 7, provided, for example, with a modem implementing the GSM and/or GPRS communication protocol, which is able to transmit to the remote operating center 4, through the communication system 5, the estimate and the vehicle information received and processed by the on-board telematic apparatus 3.

The telematic apparatus 3 further comprises a data communication device 8, which has the function of managing exchange of the vehicle data between the various control devices and sensors (not illustrated) present on board the road vehicle 2.

In particular, in the example illustrated in FIG. 1, the control device and sensors (not illustrated) communicate with one another through a data bus 8a operating according to the CAN (Controller Area Network) standard protocol, whilst the data communication device 8 comprises a CAN control module having the function of managing exchange of vehicle data through the CAN bus.

The data communication device 8 is able to supply at output a set of vehicle data, referred to hereinafter as “CAN data”, comprising the speed of the vehicle, the state of turning-on/turning-off of the brake light indicators, the engine r.p.m., and the pressure exerted on the clutch pedal by the driver.

With reference to FIG. 1, the system 1 further comprises an image-acquisition apparatus 19, which is able to supply the images acquired and, by processing thereof, the distance d1 between the road vehicle 2 and the vehicle preceding it, and/or the distance d2 between the road vehicle 2 itself and the vehicle following it. The image-acquisition apparatus 20 can comprise, for example, a pair of telecameras set one on the front side and one on the rear side of the vehicle 2 for acquiring the images of the vehicles that precede and follow the road vehicle 2.

The telematic system 1 finally comprises a processing device 9, which receives at input the CAN data, the GPS data and, preferably, but not necessarily, the distances d1 and d2 supplied by the image-acquisition apparatus 19, and is able to process said distances to determine a set of traffic indicators (described hereinafter) correlated to a condition of traffic congestion.

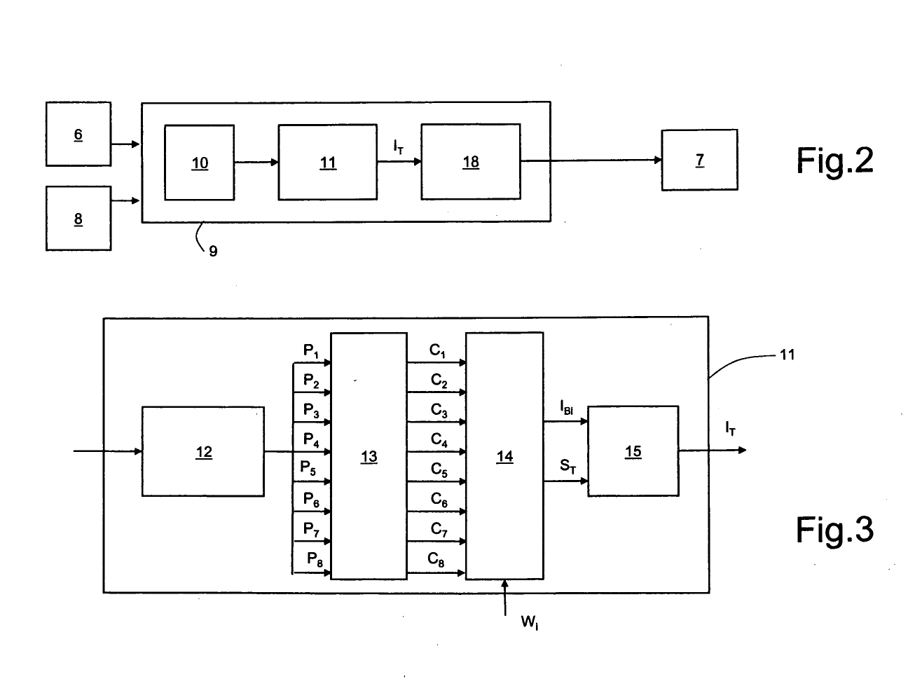

In the example shown in FIG. 2, the processing device 9 comprises: an on-board computer, which is provided with a memory 10, for example, a memory buffer within which the vehicle data acquired (CAN data, GPS data, and distances d1 and d2) are temporarily stored; a traffic-congestion detector module 11, which receives at input, from the memory 10, the vehicle data acquired and is able to implement an algorithm thereon so as to supply at output a total-traffic index I_{T}, correlated to the likelihood of presence of traffic around the road vehicle 2; and a control module 18, which receives at input the total-traffic index I_{T} and verifies whether the latter satisfies a given relation with a pre-set threshold S to identify a condition of traffic congestion so as to issue a command for transmission of the vehicle information to said remote operating center 4 when the condition of traffic congestion is verified.

With reference to FIG. 3, the traffic-congestion detector module 11 basically comprises: a parameter-calculation block 12, which receives at input, from the memory 10, the vehicle CAN data, the vehicle GPS data, and preferably, but not necessarily, the data regarding the distances d1 and d2 of the vehicles detected, and supplies at output a set of vehicle parameters Pᵢ indicating a set of operating quantities of the road vehicle 2; and a block for computing the contributions 13, which receives at input the vehicle parameters Pᵢ and supplies at output a set of contribution quantities Cᵢ (i ranging from 1 to the number of parameters considered, for example 8), each of which corresponds to a value correlated to the degree of incidence of the events associated to a given vehicle parameter Pᵢ on the likelihood of congestion of road traffic.

In other words, each contribution quantity Cᵢ represents in a numeric format the weight of the value assumed by the vehicle parameter Pᵢ on the likelihood of traffic congestion.

The traffic-congestion detector module 11 synchronizes appropriately acquisition and supply of the vehicle data contained in the memory 10 to the parameter-calculation block 12 at pre-set regular intervals, each of which hereinafter will be referred to as “basic time interval T_{B}”, having a pre-set duration (for example, approximately 10 s).

In particular, the vehicle parameters Pᵢ generated by the parameter-calculation block 12 at each basic time interval T_{B} comprise: a vehicle parameter P₁, which indicates the number N of gear changes made by the driver of the road vehicle 2 during the basic time interval T_{B}; a vehicle parameter P₂, which indicates the instantaneous acceleration of the road vehicle 2; a vehicle parameter P₃, which indicates the average of the instantaneous accelerations calculated over the basic time interval T_{B}; a vehicle parameter P₄, which indicates the average speed measured during the basic time interval T_{B}; a vehicle parameter P₅, which indicates the peak speed detected during the basic time interval T_{B}; a vehicle parameter P₆, which indicates the mean space between application of the brakes by the driver on the vehicle during the basic time interval T_{B}; a vehicle parameter P₇, which indicates the number of bends taken by the road vehicle 2 during the basic time interval T_{B}; and a vehicle parameter P₈, which indicates the number of stops that the driver of the vehicle has made in the basic time interval T_{B}.

It should be pointed out that the calculation of the parameter P₆, indicating the mean space between application of the brakes, is preferably made by the parameter-calculation block 12 by summing the speed of the vehicle measured per unit time (for example, every second) during the basic time interval T_{B}, multiplying the value obtained by the time unit and then dividing said value by the number of applications of the brakes detected during the basic time interval T_{B}, incremented by one. The number of applications of the brakes is preferably obtained by measuring the number of off-on transitions of the braking indicators (brake lights) of the vehicle.

As regards, instead, the block for computing the contributions 13, this receives at input the vehicle parameters P₁-P₈ and supplies at output the contribution quantities Ci (i ranging from 1 to 8).

In particular, the block for computing the contributions 13 supplies at output the contribution quantity C₁ containing a value that represents an estimate of the degree of correlation existing between the likelihood of presence of a traffic congestion and the number of gear changes.

In particular, the block for computing the contributions 13 determines the contribution C₁ on the basis of the parameter P₁ indicating the number of gear changes in the basic time interval T_{B}, and through a function f₁(P₁).

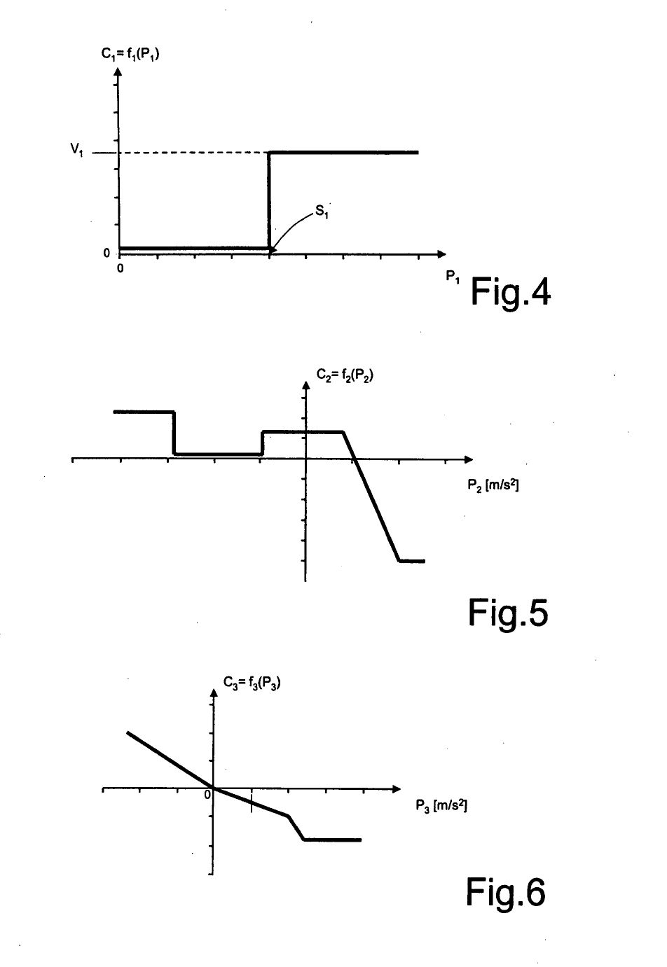

FIG. 4 shows an example of a function f₁(P₁) implemented by the block for computing the contributions 13 to determine the contribution quantity C₁=f₁(P₁) on the basis of the vehicle parameter P₁. In particular, in the example illustrated in FIG. 4, the function f₁ has a discontinuous evolution such as to supply a contribution quantity C₁ of a zero value if the parameter P₁ is less than a given threshold S₁, and supplies a given value V₁ when the parameter P₁ is greater than or equal to the threshold S₁.

It should be pointed out that the function f1 is determined on the basis of a set of results obtained by experimental tests, from which it has been found that in the absence of traffic the highest number of gear changes occurs when starting and stopping, before and after a bend, and during road change. Consequently, the function f₁ takes into account said situations and assigns a high likelihood of presence of a traffic congestion in the case where repeated gear changes occur. The correlation between gear change and traffic congestion derives from the fact that, in the presence of heavy traffic, an increase occurs in the likelihood of a continuous variation of speed being made by the driver.

The block for computing the contributions 13 moreover supplies the contribution quantity C₂ containing a value that represents an estimate of the degree of correlation existing between the likelihood of presence of a traffic congestion and the instantaneous acceleration of the road vehicle 2.

In particular, the block for computing the contributions 13 determines the contribution quantity C₂ on the basis of the parameter P₂ indicating the instantaneous acceleration by applying a function f₂(P₂). FIG. 5 shows an example of the function f₂(P₂) implemented by the block for computing the contributions 13 to determine the contribution quantity C₂ on the basis of the vehicle parameter P₂.

It should be pointed out that the function f₂ is determined on the basis of a set of results obtained from experimental tests, from which it has been found that, in the absence of traffic, the instantaneous acceleration is high during starting given the absence of obstacles in front of the road vehicle 2, whereas the instantaneous acceleration decreases when high speeds are reached. In the condition of traffic congestion, the instantaneous acceleration has, instead, reduced values also at starting, and oscillates repeatedly assuming low positive and negative values.

The block for computing the contributions 13 further supplies at output the contribution quantity C₃ containing a value that represents an estimate of the degree of correlation existing between the likelihood of presence of a traffic congestion and the average acceleration of the road vehicle 2 during the basic time interval T_{B}.

In particular, the block for computing the contributions 13 determines the contribution quantity C₃ on the basis of the parameter P₃ indicating the average acceleration through a function f₃(P₃). FIG. 6 shows an example of a function f₃(P₃) implemented by the block for computing the contributions 13 to determine the contribution quantity C3 on the basis of the vehicle parameter P₃.

It should be pointed out that the function f₃ is determined on the basis of a set of results obtained from experimental tests, from which it has been found that, when the average acceleration of the road vehicle is close to zero, there is no information useful for traffic estimation, whereas, when there is traffic congestion, the average acceleration reaches high negative values (positive evolution of f₃), and the speed tends to decrease. If, instead, the average acceleration presents high values and an increase in the speed occurs, the function f₃ assigns a negative value to the contribution quantity C₃ in so far as the presence of traffic congestion is unlikely.

The block for computing the contributions 13 moreover determines the contribution quantity C₄ containing a value that represents an estimate of the degree of correlation existing between the likelihood of presence of a traffic congestion and the average speed of the road vehicle 2 during the basic time interval T_{B}. In particular, the block for computing the contributions 13 determines the contribution quantity C₄ on the basis of the parameter P₄ indicating the average speed through a function f₄(P₄).

FIG. 7 shows an example of a function f₄(P₄) implemented by the block for computing the contributions 13 in order to determine the contribution quantity C₄ on the basis of the vehicle parameter P₄.

It should be pointed out that the function f₄ is determined on the basis of a set of results obtained from experimental tests, from which it has been found that the likelihood of traffic congestion decreases as the speed of the road vehicle increases around a pre-set threshold value S₂.

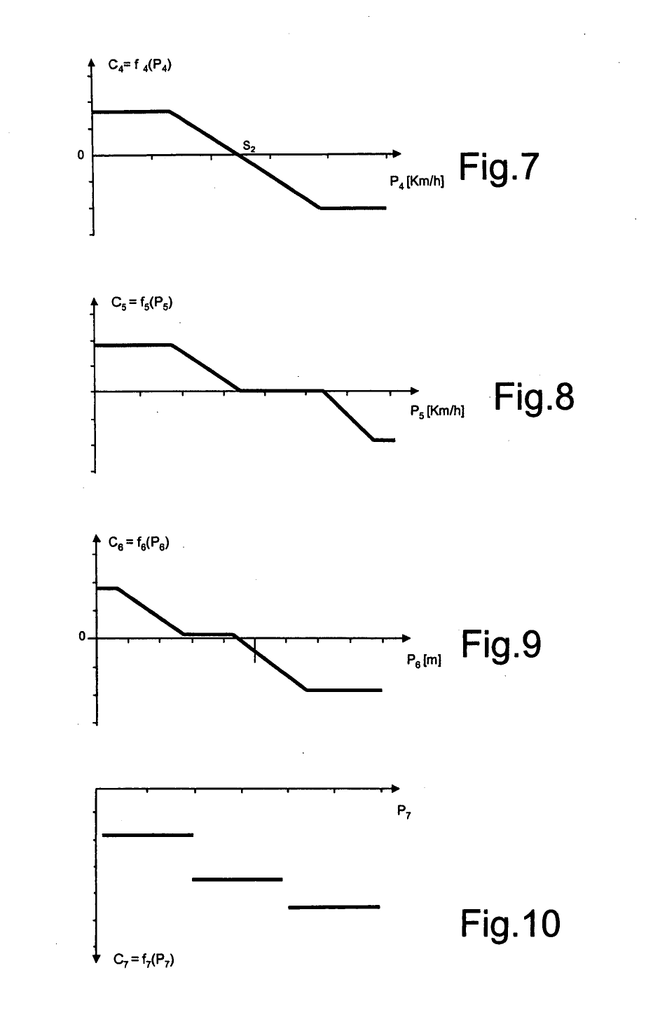

The block for computing the contributions 13 moreover determines the contribution quantity C₅ containing a value that represents an estimate of the degree of correlation existing between the likelihood of presence of a traffic congestion and the peak speed of the road vehicle 2 detected in the basic time interval T_{B}. In particular, the block for computing the contributions 13 determines the contribution quantity C₅ on the basis of the parameter P₅ indicating the peak speed by applying a function f₅(P₅). In particular, FIG. 8 shows an example of a function f₅(P₅) implemented by the block for computing the contributions 13 in order to determine the contribution quantity C₅.

The block for computing the contributions 13 moreover determines the contribution quantity C₆ containing a value that represents an estimate of the degree of correlation existing between the likelihood of presence of a traffic congestion and the mean space between application of the brakes by the driver on the vehicle during the basic time interval T_{B}.

In particular, the block for computing the contributions 13 determines the contribution quantity C₆ on the basis of the parameter P₆ indicating the mean space between application of the brakes by applying a function f₆(P₆). In particular, FIG. 9 shows an example of a function f₆(P₆) implemented by the block for computing the contributions 13 in order to determine the contribution quantity C₆.

The block for computing the contributions 13 is moreover designed to determine the contribution quantity C₇, which contains a value indicating an estimate of the degree of correlation existing between the likelihood of the presence of a traffic congestion and the number of bends taken by the road vehicle 2 in the basic time interval T_{B}.

In particular, the block for computing the contributions 13 determines the contribution quantity C₇ on the basis of the parameter P₇ indicating the number of bends taken by the road vehicle 2 through a function f₇(P₇). FIG. 10 shows an example of the function f₇(P₇) implemented by the block for computing the contributions 13 in order to determine the contribution quantity C₇.

To the above description it should be added that the function f₇ has an evolution such that, in the presence of a single bend, a reduction of the contribution quantity C₇ occurs, whereas in the presence of a number of bends a negative minimum value will be assigned to the contribution quantity C₇ itself so as to contribute to a reduction in the likelihood of presence of a traffic congestion.

The block for computing the contributions 13 is finally designed to determine the contribution quantity C₈, which contains a value indicating an estimate of the degree of correlation existing between the likelihood of presence of a traffic congestion and the number of stops made by the road vehicle 2 in the basic time interval T_{B}.

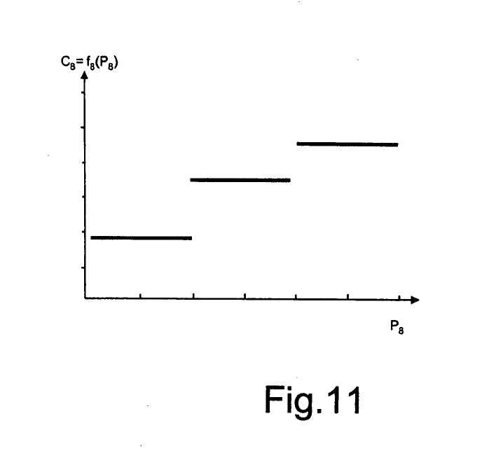

In particular, the block for computing the contributions 13 determines the contribution quantity C₈ on the basis of the parameter P₈ indicating the number of stops made by the road vehicle 2 through a function f₈(P₈). FIG. 11 shows an example of the function f₈(P₈) implemented by the block for computing the contributions 13 in order to determine the contribution quantity C₈.

To the above description it should be added that the function f₈ has an evolution such that the contribution quantity C₈ increases in proportion to the number of stops.

With reference to FIG. 3, the traffic-congestion detector module 11 further comprises an estimation block 14, which receives at input the contribution quantities C₁-C₈ and supplies at output a basic traffic indicator I_{B}. In particular, the estimation block 14 determines the basic traffic indicator I_{B} via the following weighted sum of the contribution quantities Cᵢ:
I_{B}=C₁*W₁+C₂*W₂+C₃*W₃+C₄*W₄+C₅*W₅+C₆*W₆+C₇*W₇+C₈*W₈;
where W₁-W₈ are pre-set relative weights, each of which is assigned to a respective contribution quantity Cᵢ and indicates the relative importance of each parameter Pᵢ on the traffic estimate.

In other words, each quantity Wᵢ represents in a numeric format the relative weight on the likelihood of traffic congestion of the value assumed by the vehicle parameter Pᵢ with respect to the values assumed by the other vehicle parameters.

It should be pointed out that the basic traffic indicator I_{B} can also be determined on the basis of a subset of parameters P₁-P₈ described above. For example, the basic traffic indicator I_{B} can be determined only on the basis of the parameter P₄ associated to the average speed, by applying the relation I_{B}=C₄*W₄, and/or on the basis of the parameter P₅ associated to the peak speed, by applying the relation I_{B}=C₅*W₅.

It should, however, be added that experimental tests have demonstrated that an optimal estimation of the traffic can be obtained using all the vehicle parameters P₁-P₈ described above with an appropriate set of weights W₁-W₈.

The estimation block 14, in addition to calculating the basic traffic indicator I_{B}, also generates at output a signal of mobility ST, which encodes a state of mobility of the road vehicle.

In detail, in the case where the peak speed of the road vehicle 2 contained in the vehicle parameter P₅ is other than zero, assigned to the signal of mobility ST is a state of motion, designated hereinafter by “MOTION”, whereas, if the peak speed is zero, assigned to the signal of mobility ST is a state of stop, designated hereinafter by “STOP”.

The traffic-congestion detector module 11 further comprises a decision-making block 15, which receives at input the basic traffic indicators I_{Bi}, which are generated by the estimation block 14 during a set of basic time intervals designated hereinafter by T_{Bi}, which define as a whole an examination time interval T_{E}. Hereinafter, for simplicity of description, an examination time interval T_{E} will be considered containing a number E of basic time intervals T_{Bi} (with i ranging from 1 and E).

The decision-making block 15 has the function of processing the basic traffic indicators I_{Bi} received at input during the examination time interval T_{E} in order to supply at output a total-traffic index I_{T} correlated to the condition of traffic congestion around the road vehicle 2.

In particular, during processing by the decision-making block 15, the examination time interval T_{E} is split into a number K of temporal sub-intervals, each of which, designated hereinafter by Aᵢ (with i ranging from 1 and K), comprises a number M of basic time intervals T_{Bi}.

The temporal sub-intervals Aᵢ are conveniently fixed in order to analyse, in addition to the intensity of the traffic during the examination time interval T_{E}, also the temporal evolution of the traffic itself, in such a way as to prevent transient phenomena, not strictly correlated to a condition of traffic congestion, such as for example sharp stops, from erroneously being perceived as conditions associated to the presence of traffic.

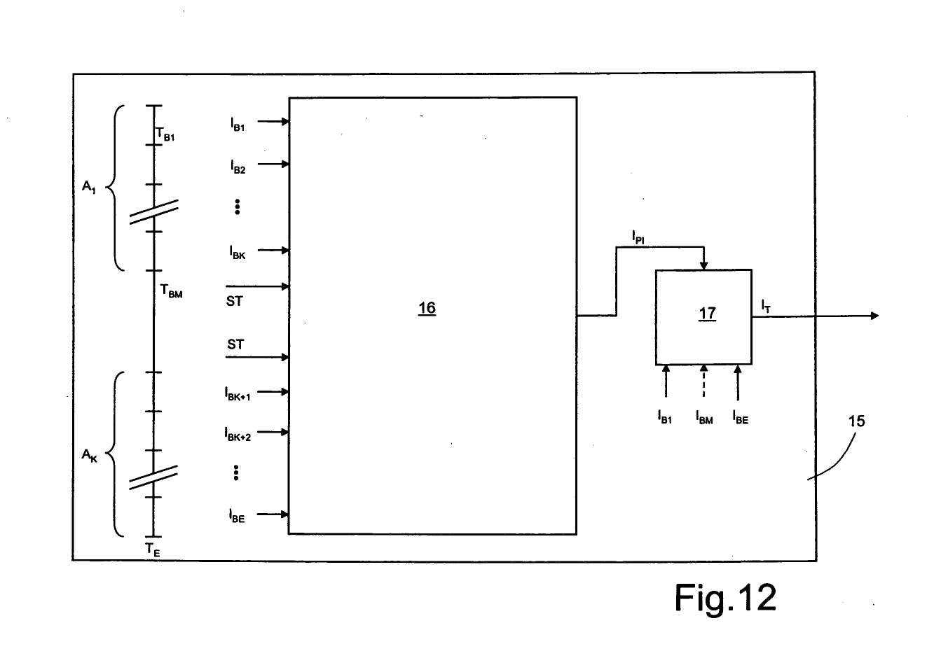

With reference to the example shown in FIG. 12, the decision-making block 15 is provided with a computing module 16, which calculates for each temporal sub-interval Aᵢ a partial indicator I_{Pi}, which is a function of the mean value and of the variance of the basic traffic indicators I_{Bi} regarding the basic time intervals of a MOTION type belonging to said sub-interval Aᵢ.

In greater detail, the partial indicator I_{Pi} can be determined, for example, through the following function:

$${I}_{Pi} = f ( M , D ) = \{ \begin{matrix}M & if M > {M}_{s} and D < {D}_{s} \\ 0 & otherwise\end{matrix}$$

where: M is the mean value of the basic traffic indicators I_{Bi} associated to the basic time intervals T_{Bi} of a MOTION type belonging to the temporal sub-interval Aᵢ; D is the variance of the basic traffic indicators I_{Bi} associated to the basic time intervals T_{Bi} of a MOTION type belonging to the temporal sub-interval Aᵢ; and Mₛ and Dₛ are pre-set thresholds.

The decision-making block 15 is further provided with a conditional module 17, which receives at input the values of the basic traffic indicators I_{Bi} calculated in the examination time interval T_{E} and the partial indicators I_{Pi} and supplies at output the total-traffic index I_{T}.

In particular, the conditional module 17 is able to generate the total-traffic index I_{T} to be supplied at input to the control module 18 on the basis of three different conditions.

In greater detail, the conditional module 17 assigns to the total-traffic index I_{T} the value of the total-traffic index I_{T} determined during the examination interval T_{E} prior to the current examination interval T_{E}, when a first condition is verified. In the case in point, the first condition is verified when, during the current examination interval T_{E}, the road vehicle 2 remains stationary. In particular, the first condition is verified when, in all of the basic time intervals T_{bi}, a state of motion ST corresponding to STOP is detected.

If, instead, the conditional module 17 detects a second condition, it then calculates the total-traffic index I_{T} by calculating an average of the basic traffic indicators I_{Bi} associated to the basic intervals T_{Bi} of a MOTION type present in the examination interval T_{E}. In particular, the conditional module 17 detects the second condition when each partial indicator I_{Pi} satisfies a relation with a pre-set threshold S depending upon (associated to) the corresponding temporal sub-interval Aᵢ. In particular, the second condition can be satisfied when the partial indicator I_{Pi} is greater than the pre-set threshold S.

Finally, the conditional module 17 assigns to the total-traffic index I_{T} a zero value when it detects a third condition, which occurs when the first condition and/or the second condition are/is not verified.

As regards the control module 18 shown in FIG. 2, this receives at input the total-traffic index I_{T} and compares it with a pre-set threshold I_{S} in order to determine, on the basis of the results of said comparison, a condition of traffic congestion or a condition of smooth traffic flow. In particular, if the total-traffic index I_{T} exceeds the threshold I_{S}, the control module 18 detects a condition of traffic congestion and issues a command to the communication device 7 for transmission of the information regarding the traffic to the remote operating center 4.

According to a different embodiment, the control module 18 can detect the condition of traffic congestion when a set of total-traffic indices I_{T} determined in corresponding consecutive examination time intervals T_{E} exceed the threshold I_{S}.

It should be pointed out that the information transmitted to the operating center 4 can comprise: the CAN data, and/or the GPS data, and/or the distances d1 and d2, and/or the vehicle parameters Pᵢ, and/or the contribution quantities Cᵢ, and/or the images acquired by the telecameras, and/or the basic traffic indicators I_{Bi}, and/or the total-traffic indicators I_{T}.

If, instead, the total-traffic index I_{T} does not exceed the threshold I_{S} during at least one examination time interval T_{E}, the control module 18 identifies a condition of smooth traffic flow and hence advantageously does not activate any transmission of the information gathered to the remote operating center 4.

According to a different embodiment, if the total-traffic index I_{T} does not exceed the threshold Is during a set of consecutive examination time intervals T_{E}, the control module 18 identifies a condition of smooth traffic flow and hence advantageously does not activate any transmission of the information gathered to the remote operating center 4.

The remote operating center 4 receives the information transmitted by the telematic apparatuses 3 installed on board the road vehicles 2 and stores it in one or more databases contained therein. In particular, the remote operating center 4 stores in each database the important information transmitted by each telematic apparatus 3 regarding the last examination time intervals T_{E} whereby a condition of traffic congestion has been detected.

The traffic-detection system 1 described above presents the advantages outlined in what follows. In the first place, the amount of information on the vehicle traffic transmitted to the remote operating center is markedly reduced, thus leading to a marked reduction both in the transmission costs and in the dimensions of the databases used in the remote operating center itself. It is evident, in fact, that the on-board telematic apparatus 3 limits transmission to the remote operating center of the vehicle information that is effectively useful for determining situations of traffic congestion.

In addition, the system 1 is extremely simple and economically advantageous to implement: it is, in fact, sufficient to equip the road vehicle 2 with a GPS receiver device and with an on-board computer able to receive CAN data. Said solution reduces the hardware costs required on board the vehicle and reduces to zero the costs linked to operations of maintenance and/or updating of software typically made in detection systems that use digital road maps. It is known, in fact, that said systems require the use of processors that are particularly powerful from the computational standpoint in so far as they have to perform burdensome processing operations on the images that represent the road maps to enable each time identification of their own position.

Finally, it is clear that modifications and variations can be made to the detection system described and illustrated herein, without thereby departing from the scope of the present invention, as defined by the annexed claims.

What is claimed is:

1. A telematic apparatus, which can be installed on board a road vehicle for detecting a set of vehicle information regarding the road traffic present around the road vehicle itself, and is designed to transmit said vehicle information to a remote operating center that processes it in order to supply a set of indications regarding the condition of said road traffic; said telematic apparatus comprising:
a traffic-congestion detector means designed to estimate, as a function of a set of vehicle parameters correlated to a set of operating quantities of said road vehicle, a total-traffic index correlated to the presence of a condition of congestion of the road traffic; and
a control means designed to verify whether said total-traffic index satisfies a first relation with a pre-set threshold, and to issue a command for transmission of said vehicle information regarding the road traffic present around the road vehicle to said remote operating center when said relation is satisfied.

2. The telematic apparatus according to claim 1, wherein said traffic-congestion detector means comprise first computing means, which receive said vehicle parameters and supply a set of contribution quantities, each of which corresponds to a value correlated to the degree of incidence of the events associated to a given vehicle parameter on the likelihood of the presence of a condition of congestion of the road traffic.

3. The telematic apparatus according to claim 2, wherein said traffic-congestion detector means comprise estimation means designed to process said contribution quantities to determine in a pre-set basic interval a basic traffic indicator via the following relation:
I_{B}=C₁*W₁+C₂*W₂+ . . . +Cₙ*Wₙ;
where W₁-Wₙ are pre-set weights assigned to each contribution quantity Cᵢ.

4. The telematic apparatus according to claim 3, wherein said traffic-congestion detector means comprise decision-making means designed to process a plurality of basic traffic indicators calculated during respective basic time intervals contained in a pre-set examination time interval so as to supply at output said total-traffic index.

5. The telematic apparatus according to claim 4, in which said examination time interval comprises a set of temporal sub-intervals, each of which comprises a pre-set number of basic time intervals; said telematic apparatus being said decision-making means comprise a computing module designed to calculate, for each temporal sub-interval, a partial indicator as a function of the mean value and of the variance of the basic traffic indicators calculated selectively in the basic time intervals in which a state of motion of the vehicle is verified.

6. The telematic apparatus according to claim 5, wherein said decision-making means comprise a conditional module designed to determine said total-traffic index as a function of the basic traffic indicators and of said partial indicators calculated in said examination time interval.

7. The telematic apparatus according to claim 6, wherein said conditional module is designed to assign to the total-traffic index a value of the total-traffic index determined during an examination interval that precedes the current examination interval if a first vehicle condition corresponding to a condition of stationary road vehicle is verified.

8. The telematic apparatus according to claim 7, wherein, in the case where a second vehicle condition is verified, said conditional module determines the total-traffic index, carrying out an average of the basic traffic indicators calculated selectively in the basic time intervals in which a state of motion of the vehicle is verified.

9. The telematic apparatus according to claim 8, wherein said conditional module verifies said second vehicle condition when each partial indicator determined in the examination time interval satisfies a relation with a pre-set threshold depending upon the sub-interval.

10. The telematic apparatus according to claim 9, wherein said conditional module assigns to the total-traffic index a zero value, when neither of said first vehicle condition or said second vehicle condition is verified.

11. The telematic apparatus according to claim 1, wherein said traffic-congestion detector means are designed to estimate said total-traffic index as a function of a set of vehicle parameters correlated to a set of operating quantities supplied by a telematic platform based upon xFCD.

12. The telematic apparatus according to claim 2, wherein said traffic-congestion detector means are designed to estimate said total-traffic index as a function of a set of vehicle parameters correlated to a set of operating quantities supplied by a telematic platform based upon xFCD.

13. The telematic apparatus according to claim 3, wherein said traffic-congestion detector means are designed to estimate said total-traffic index as a function of a set of vehicle parameters correlated to a set of operating quantities supplied by a telematic platform based upon xFCD.

14. The telematic apparatus according to claim 4, wherein said traffic-congestion detector means are designed to estimate said total-traffic index as a function of a set of vehicle parameters correlated to a set of operating quantities supplied by a telematic platform based upon xFCD.

15. The telematic apparatus according to claim 5, wherein said traffic-congestion detector means are designed to estimate said total-traffic index as a function of a set of vehicle parameters correlated to a set of operating quantities supplied by a telematic platform based upon xFCD.

16. The telematic apparatus according to claim 6, wherein said traffic-congestion detector means are designed to estimate said total-traffic index as a function of a set of vehicle parameters correlated to a set of operating quantities supplied by a telematic platform based upon xFCD.

17. The telematic apparatus according to claim 7, wherein said traffic-congestion detector means are designed to estimate said total-traffic index as a function of a set of vehicle parameters correlated to a set of operating quantities supplied by a telematic platform based upon xFCD.

18. The telematic apparatus according to claim 8, wherein said traffic-congestion detector means are designed to estimate said total-traffic index as a function of a set of vehicle parameters correlated to a set of operating quantities supplied by a telematic platform based upon xFCD.

19. The telematic apparatus according to claim 9, wherein said traffic-congestion detector means are designed to estimate said total-traffic index as a function of a set of vehicle parameters correlated to a set of operating quantities supplied by a telematic platform based upon xFCD.

20. A system for detection of vehicle traffic comprising a plurality of road vehicles installed on board each of which is a telematic apparatus, which is designed to detect a set of vehicle information regarding the road traffic present around the road vehicle itself, and is able to transmit said vehicle information to a remote operating center for controlling traffic; said system for detection of vehicle traffic being wherein said telematic apparatus comprises:
a traffic-congestion detector means designed to estimate, as a function of a set of vehicle parameters correlated to a set of operating quantities of said road vehicle, a total-traffic index correlated to the presence of a condition of congestion of the road traffic; and
a control means designed to verify whether said total-traffic index satisfies a first relation with a pre-set threshold, and to issue a command for transmission of said vehicle information regarding the road traffic present around the road vehicle to said remote operating center when said relation is satisfied.
